(19) United States
(12) Patent Application Publication
(10) Pub. No.: US 2024/0054409 A1
(43) Pub. Date: Feb. 15, 2024

(54) SYSTEMS AND METHODS FOR LOCATION-BASED EVENT MATCHING

(71) Applicant: Matthew KASHAN, Austin, TX (US)

(72) Inventor: Matthew KASHAN, Austin, TX (US)

(21) Appl. No.: 18/269,326

(22) PCT Filed: Dec. 20, 2021
(86) PCT No.: PCT/US2021/064906

§ 371 Date: Jun. 23, 2023

Related U.S. Application Data
(60) Provisional application No. 63/130,499, filed on Dec. 24, 2020.

(51) Int. Cl. G06Q 10/02; H04L 67/52; G06Q 50/00

(52) U.S. Cl. CPC G06Q 10/02; H04L 67/52; G06Q 50/01

(57) ABSTRACT

A computer-implemented method of location-based event matching includes receiving by a server from a first user device, a plurality of events. Each event of the plurality of events includes a geographic location and a user profile of an event creator. The method further includes transmitting to the first user device, an indication to display a graphical representation of the plurality of events; receiving by the server, from the first user device, a preference indication for an event of the plurality of events; determining, by the server, a potential match based on the geographic location and the preference indication; transmitting to a second user device, an indication to display a graphical representation of the potential match; receiving from the second user device, approval of the potential match as an approved match; and transmitting to the first user device, an indication to display a graphical representation of the approved match.

### CROSS-REFERENCE TO RELATED APPLICATIONS

The present application claims the benefit of and priority to U.S. Provisional Patent Application No. 63/130,499, filed on Dec. 24, 2020, the entire contents of which are hereby incorporated herein by reference.

### TECHNICAL FIELD

The present application relates to systems and methods for event matching, and in particular, to location-based event matching.

### SUMMARY

In accordance with aspects of the present disclosure, a computer-implemented method of location-based event matching presented. The method includes transmitting to a first user device, a plurality of events. Each event of the plurality of events includes a geographic location and a user profile of an event creator. The method further includes transmitting to the first user device, an indication to display a graphical representation of the plurality of events; receiving by the server, from the first user device, a preference indication for an event of the plurality of events; determining, by the server, a potential match based on the geographic location and the preference indication; transmitting by the server to a second user device, an indication to display a graphical representation of the potential match; receiving by the server, from the second user device, an approval of the potential match as an approved match; and transmitting to the first user device, an indication to display a graphical representation of the approved match.

In accordance with aspects of the present disclosure, each event of the plurality of events may further include a description of the event, a time, a date, and/or a category.

In accordance with aspects of the disclosure, displaying the plurality of events may include filtering the plurality of events to be displayed on the user device based on a category and displaying, on the user device, a graphical representation of the filtered plurality of events.

In an aspect of the present disclosure, the category may include arts, crafts, adventure, classes, sports, fitness, recreational, food, drink, events, shows, local attractions, vehicles, and/or all events.

In another aspect of the present disclosure, the filtering may be further based on a maximum geographic distance between the user and each event of the plurality of events, a gender interest, and/or an age range.

In yet another aspect of the present disclosure, displaying the plurality of events may include displaying a description of the event, a map of the event geographic location, a profile of the event creator, an indication of a countdown time until a start time of the event, and/or a checklist.

In a further aspect of the present disclosure, receiving the preference indication for an event of the plurality of events may include prompting the user to submit a preference indication for the event.

In yet a further aspect of the present disclosure, the method may further include, after receiving the preference indication for an event of the plurality of events, storing in a shopping cart the least one event based on the received indication.

In an aspect of the present disclosure, receiving the preference indication for the event of the plurality of events may include receiving from the first user device, a gesture associated with the graphical representation of the plurality of events indicating a preference for one of the events of the plurality of events.

In another aspect of the present disclosure, the determining the potential match may be further based on matching a user profile to an event creator profile.

In accordance with aspects of the present disclosure, a system for location-based event matching is presented. The system includes a server that includes a processor and a memory. The memory includes instructions stored thereon, which when executed by the processor cause the system to receive from a first device, from the server, a plurality of events, each event of the plurality of events includes a geographic location and a user profile of an event creator; transmit to the first user device, a graphical representation of the plurality of events; transmit, by the first user device to the server, a preference indication for an event of the plurality of events; determine, by the server, a potential match based on the geographic location and the preference indication; display, on the second user device, a graphical representation of the potential match; receive, from the second user device, approval of the potential match as an approved match; and display, on the first user device, a graphical representation of the approved match.

In yet another aspect of the present disclosure, each event of the plurality of events may further include a description of the event, a time, a date, and/or a category.

In a further aspect of the present disclosure, when displaying the plurality of events, the instructions, when executed by the processor, may further cause the system to filter the plurality of events to be displayed on the user device based on a category and display, on the user device, a graphical representation of the filtered plurality of events.

In an aspect of the present disclosure, the category may include arts, crafts, adventure, classes, sports, fitness, recreational, food, drink, events, shows, local attractions, vehicles, and/or all events.

In another aspect of the present disclosure, the filtering may be further based on a maximum geographic distance between the user and each event of the plurality of events, a gender interest, and/or an age range.

In yet another aspect of the present disclosure, when displaying the plurality of events, the instructions, when executed by the processor, may further cause the system to display a description of the event, a map of the event geographic location, a profile of the event creator, an indication of a countdown time until a start time of the event, and/or a checklist.

In a further aspect of the present disclosure, when receiving the preference indication for an event of the plurality of events, the instructions, when executed, may further cause the system to prompt the user to submit a preference indication for the event.

In yet a further aspect of the present disclosure, after receiving the preference indication for an event of the plurality of events, the instructions, when executed by the processor, may further cause the system to store in a shopping cart the least one event based on the received indication.

In yet a further aspect of the present disclosure, when receiving a preference indication for the instructions, when executed by the processor, may further cause the system to receive from the first user device, a gesture associated with the graphical representation of the plurality of events indicating preference for one of the events of the plurality of events.

In accordance with aspects of the present disclosure, a non-transitory computer-readable storage medium in which is stored a program for causing a computer to execute a computer-implemented method of location-based event matching is presented. The method includes receiving by a server from by a first user device a plurality of events. Each event of the plurality of events includes a geographic location and a user profile of an event creator. The method further includes transmitting to the first user device, a graphical representation of the plurality of events for display; receiving by the server, from the first user device, a preference indication for an event of the plurality of events; determining, by the server, a potential match based on the geographic location and the preference indication; transmitting to a second user device, a graphical representation of the potential match for display; receiving by the server, from the second user device, an approval of the potential match as an approved match; and transmitting to the first user device, a graphical representation of the approved match, for display.

Further details and aspects of exemplary aspects of the present disclosure are described in more detail below with reference to the appended figures.

### BRIEF DESCRIPTION OF THE DRAWINGS

A better understanding of the features and advantages of the disclosed technology will be obtained by reference to the following detailed description that sets forth illustrative aspects, in which the principles of the technology are utilized, and the accompanying drawings of which:

FIG. 1 is a network diagram illustration, which shows an exemplary networked environment for a computer-implemented method of location-based event matching in accordance with aspects of the present disclosure;

FIG. 2 is a block diagram of an exemplary server of FIG. 1 in accordance with aspects of the present disclosure;

FIG. 3 is a flow diagram for a method of location-based event matching in accordance with the present disclosure;

FIG. 4 is an exemplary wireframe of a discovery screen of an aspect of the system of FIG. 1;

FIG. 5 is an exemplary wireframes of a discovery filter screen of an aspect of the system of FIG. 1;

FIGS. 6A-6C are exemplary wireframes of event detail screens of an aspect of the system of FIG. 1;

FIG. 7 is an exemplary wireframe of an event detail screen of an aspect of the system of FIG. 1;

FIG. 8 is an exemplary wireframe of an engagement screen of an aspect of the system of FIG. 1;

FIG. 9 is an exemplary wireframe of a message screen of an aspect of the system of FIG. 1; and

FIGS. 10A-10B are example wireframes of event creation screens of an aspect of the system of FIG. 1.

### DETAILED DESCRIPTION

This disclosure relates to systems and methods for event matching, and in particular, to location-based event matching.

Although the present disclosure will be described in terms of specific aspects, it will be readily apparent to those skilled in this art that various modifications, rearrangements, and substitutions may be made without departing from the spirit of the present disclosure. The scope of the present disclosure is defined by the claims appended hereto.

For purposes of promoting an understanding of the principles of the present disclosure, reference will now be made to exemplary aspects illustrated in the drawings, and specific language will be used to describe the same. It will nevertheless be understood that no limitation of the scope of the present disclosure is thereby intended. Any alterations and further modifications of the inventive features illustrated herein, and any additional applications of the principles of the present disclosure as illustrated herein, which would occur to one skilled in the relevant art and having possession of this disclosure, are to be considered within the scope of the present disclosure.

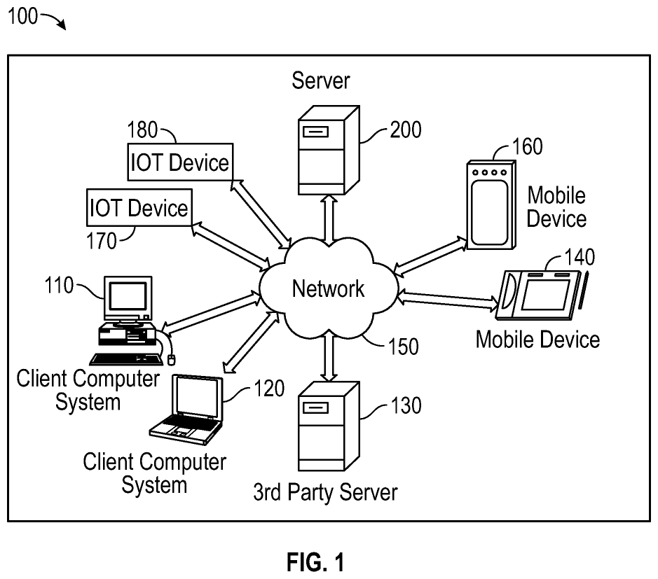

Referring to FIG. 1, there is shown an illustration of an exemplary networked environment 100 in accordance with aspects of the present disclosure. The system 100 includes one or more client computer systems 110, 120, a network 150, a server 200, and one or more mobile device 140, 160. The mobile device(s) 140, 160, or the client computer system 110, 120, communicate with the server 200 across the network 150 to manage data. In one example, the server 200 may store a plurality of events, a user's personal profile, and settings. The server 200 may communicate the plurality of events to a user device 140 for display to a user.

In the illustrated aspect, the networked environment 100 includes a third party server 130. In various aspects, the third-party server 130 can store and communicate user tasks, and the server 200 can import such user tasks from the third party server 130. In various aspects, data, services, or applications from third-party servers 130 may be used by the server 200 for scheduling operations. Such data from third-party servers 130 can include, for example, a user's available time, events, tags, or the weather forecast.

The network 150 may be wired or wireless and can utilize technologies such as Wi-Fi, Ethernet, Internet Protocol, 3G, and/or 4G, or other communication technologies. The network 150 may include, for example, but is not limited to, a cellular network, residential broadband, satellite communications, private network, the Internet, local area network, wide area network, storage area network, campus area network, personal area network, or metropolitan area network.

The term “application” may include a computer program designed to perform particular functions, tasks, or activities for the benefit of a user. Application may refer to, for example, software running locally or remotely, as a standalone program or in a web browser, or other software which would be understood by one skilled in the art to be an application. An application may run on the server 200 or on a user device, including, for example, on a mobile device 140 or a client computer system 110.

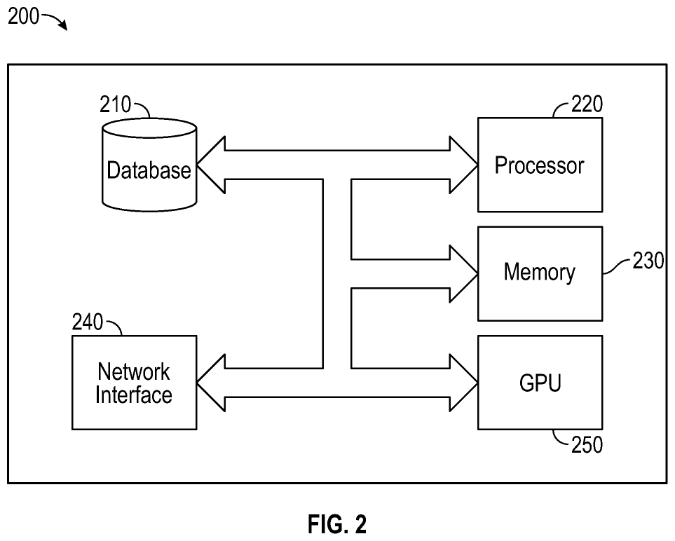

Referring now to FIG. 2, an illustration of exemplary components of the server 200 of FIG. 1, is shown. The server 200 includes, for example, a database 210, one or more processors 220, at least one memory 230, and a network interface 240.

The database 210 can be located in storage. The term “storage” may refer to any device or material from which information may be capable of being accessed or reproduced or held in an electromagnetic or optical form for access by a computer processor. A storage may be, for example, volatile memory such as RAM, non-volatile memory, which permanently hold digital data until purposely erased, such as flash memory, magnetic devices such as hard disk drives, and optical media such as a CD, DVD, Blu-ray disc, or the like.

In various aspects, data may be stored on the server 200, including, for example, user-selected and/or created events, preferences, historical data, documents, and/or other data. The data can be stored in the server database 210 and sent via the system bus to the processor 220.

As will be described in more detail later herein, the processor 220 executes various processes based on instructions that can be stored in the server memory 230 and utilizing the data from the database 210. With reference also to FIG. 1, a request from a user device, such as a mobile device 140 or a client computer 110, can be communicated to the server 200, through the server's network interface 240. For example, a user can conduct scheduling operations on a user computer 110. The server 200 can access the user's event schedule, apply processing to the user's event schedule, and provide the user with an updated schedule as a result.

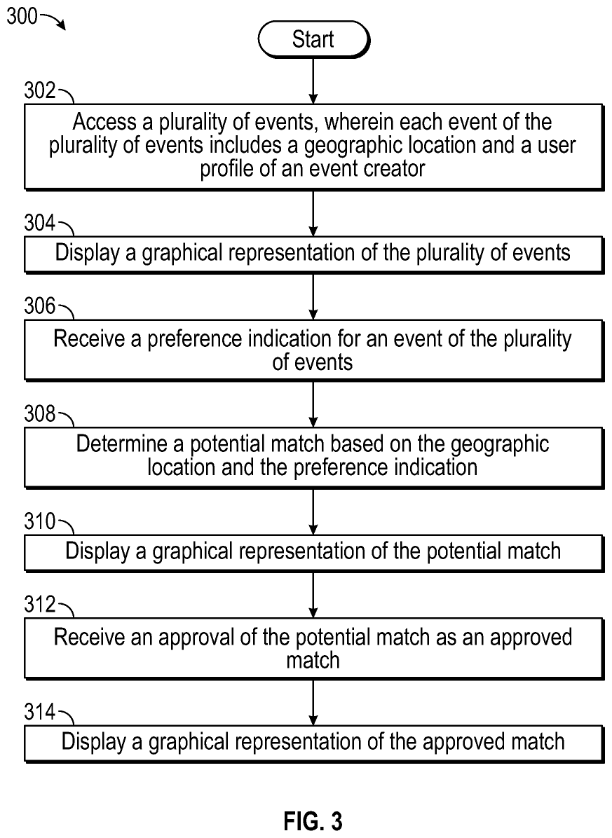

Referring to FIG. 3, there is shown a flow chart of an exemplary computer-implemented method 300 of location-based event matching in accordance with aspects of the present disclosure. As mentioned above, a user may maintain a calendar of events at client computer systems 110, 120. In accordance with aspects of the present disclosure, the server 200 operates to improve or optimize the matching of a user to an event. Although the steps of FIG. 3 are shown in a particular order, the steps need not all be performed in the specified order, and certain steps can be performed in another order. For simplicity, FIG. 3 will be described below with the server 200 performing the operations. However, in various aspects, the operations of FIG. 3 may be performed in part by the server 200 of FIG. 1 and in part by another device, such as the mobile device(s) 140, 160 or at client computer systems 110, 120. These variations are contemplated to be within the scope of the present disclosure.

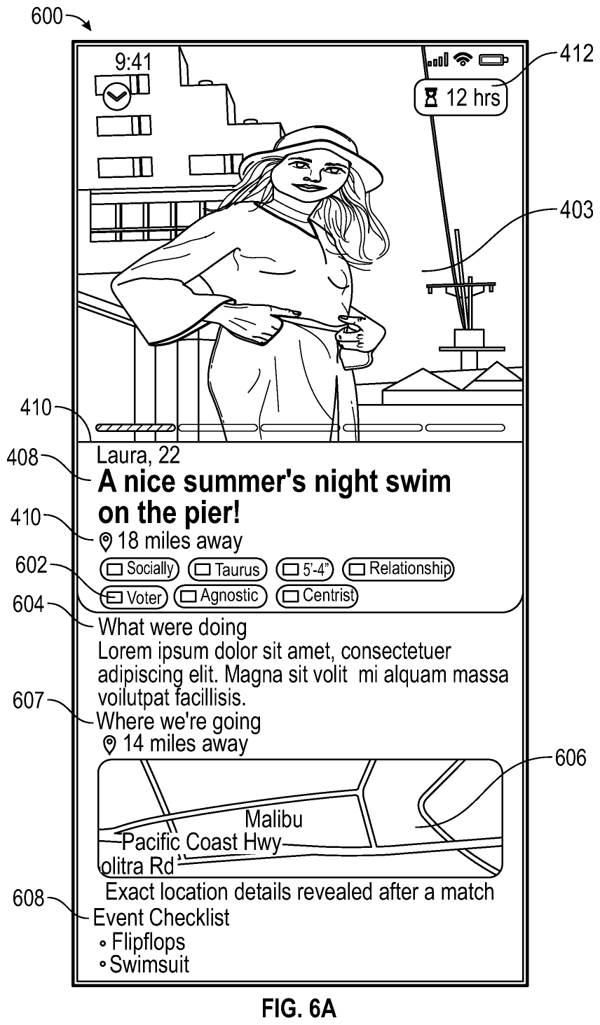

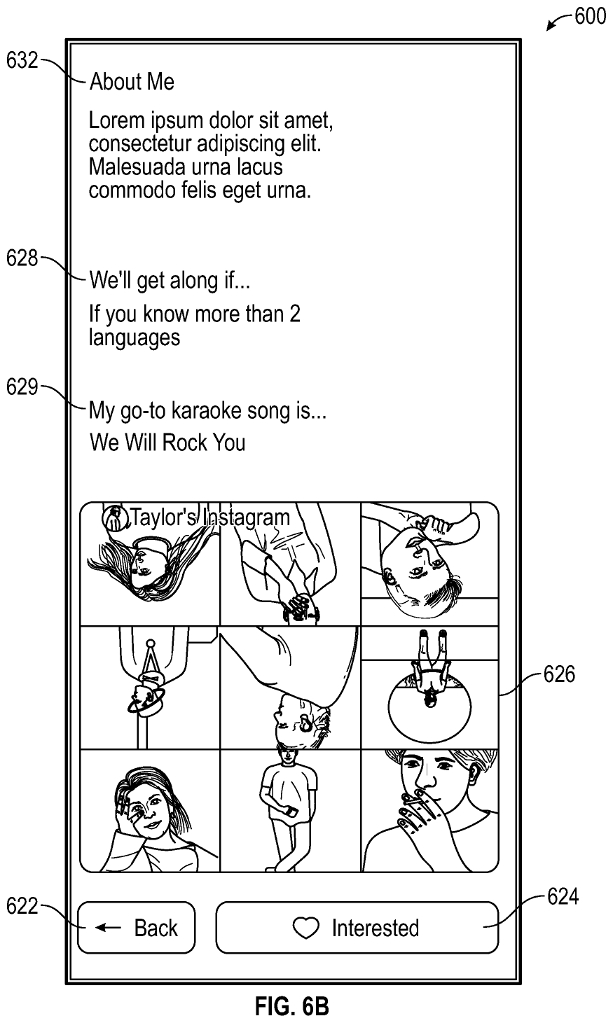

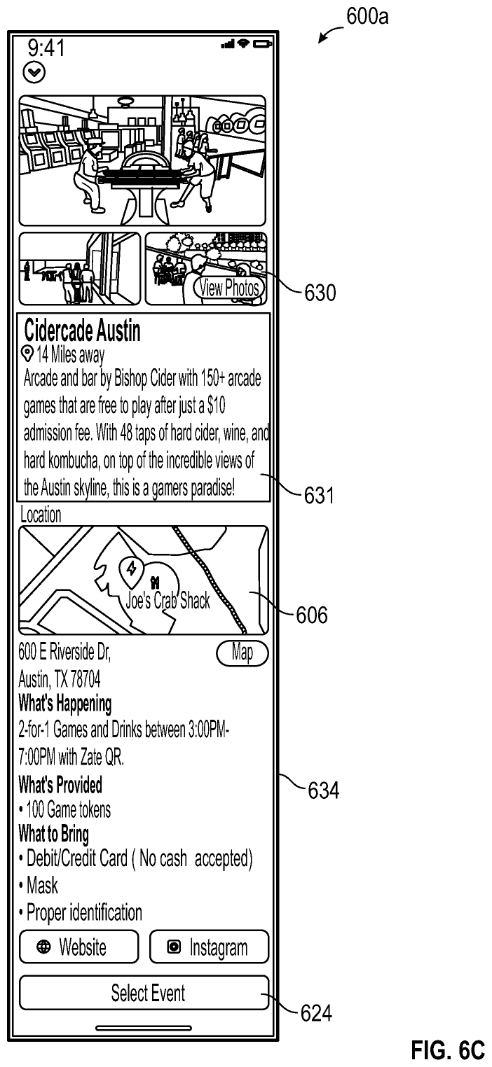

Initially, at step 302, the operation accesses by a first user device, a plurality of events. The events may be stored on a server. Each event includes a geographic location and a user profile of an event creator. Each event may further include a description of the event, a time, a date, and/or a category. For example, a first user named Alexandra may create an event, such as a “road trip to Malibu in twelve hours” (See FIG. 6B). Alexandra's user profile may include, for example, her age, approximate location, height, and relationship status.

Next, at step 304, the operation displays, on the first user device, a graphical representation of the plurality of events. For example, the first user's device may display a graphical representation of a number of events, such as the “Road trip to Malibu in twelve hours,” “Movie and a dinner,” etc. Displaying the plurality of events may include displaying, for example, a description of the event, a map of the event's geographic location, a profile of the event creator, an indication of a countdown time until a start time of the event, and/or a checklist. The checklist may include items needed for the event. For example, flip flops and a swimsuit may be included on a checklist for an event at a beach.

In aspects, the operation may include filtering the plurality of events to be displayed on the user device based on a category and displaying, on the user device, a graphical representation of the filtered plurality of events. The category may include but is not limited to, for example, arts, crafts, adventure, classes, sports, fitness, recreational, food, drink, events, shows, local attractions, vehicles, and/or all events. Multiple categories may be selected, for example, adventure and sports. In aspects, filtering may be further based on a maximum geographic distance between the user and each event of the plurality of events, a gender interest, and/or an age range. The operation may display, on the user device, a graphical representation of the filtered plurality of events.

Next, at step 306, the operation receives by the server, from the first user device, a preference indication for an event of the plurality of events. For example, the preference indication may include “liking” or “favoriting” the event. The operation may prompt the user to submit a preference indication for the event. In aspects, the operation may detect, from the user device, a gesture associated with the graphical representation of the plurality of events indicating a preference for one of the events of the plurality of events. Any number of gestures is contemplated by the disclosure.

The user may select more than one event that they are interested in. For example, they may store three or four events they are interested in, in a “shopping cart” before deciding on which event they would like to go on.

Next, at step 308, the operation determines, by the server, a potential match based on the geographic location and the preference indication. The geographic location and the preference indication may we weighted. Thus enabling, for example, geographic location to have more weight in the matching decision. The determination may be based on, for example, a machine learning network trained on previous matches and/or by pattern matching. This has the benefit of making matches more efficient over current technology.

In aspects, the potential match may be predicted by generating, based on the geographic location and the preference indication, a data structure that is formatted to be processed through one or more layers of a machine learning model. The data structure may have one or more fields structuring data. The potential match may further be predicted by processing data that includes the data structure, through each of the one or more layers of the machine learning model that has been trained to predict a potential match; and generating, by an output layer of the machine learning model, an output data structure. The output data structure may include one or more fields structuring data indicating a likelihood that an event is a potential match. The potential match may further be predicted by processing the output data structure to determine whether data organized by the one or more fields of the output data structure satisfies a predetermined threshold. The output data structure includes one or more fields structuring data indicating a likelihood that a particular event may be a potential match. The potential match may further be predicted by generating the prediction based on the output data of the machine learning model. The prediction includes the potential match.

Next, at step 310, the operation displays, on a second user device, a graphical representation of the potential match (FIG. 6C). For example, a graphical representation of the potential match is displayed on the event creator's user device.

Next, at step 312, the operation receives by the server, from the second user device (e.g., the device of the event planner), approval of the potential match as an approved match. The event creator then approves on their device the potential matches. In aspects, the operation enables the event planner to control interaction with the user.

Next, at step 314, the operation displays, on the first user device, a graphical representation of the approved match.

In aspects, a user may plan events and/or shop for events to attend.

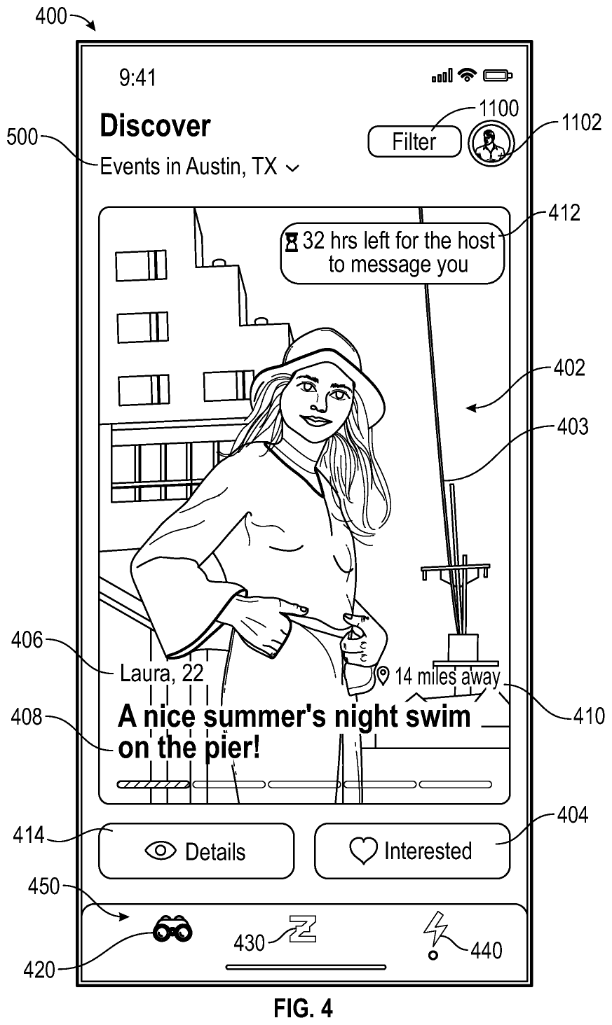

Referring to FIG. 4, a discovery screen 400 is shown. The discovery screen 400 generally includes one or more event overview windows 402 configured to show information relating to the displayed event, a user profile button 1102, a viewing filter button 500 configured to filter the events by various criteria (e.g., events in Austin, TX), a discover button 420 configured to enable a user to go “shopping” for events, a “my event” button 430 configured to display events the user has signed up for, and an engage button 440. Although the term “button” may be used to illustrate an example, other user input methods may be utilized, including, but not limited to clickable icons, dropdowns, radio buttons, or other suitable input means. It is contemplated that various buttons or indicators on the screens may include an indicator such as a color to indicate who owns the event. For example, if the user created the event, the button may be green, if someone else created the event it may be purple. Other colors are contemplated to be used for the indication.

The event overview window 402 includes an image window 403 configured to show an image chosen by the event planner, an event planner name 406 (e.g., Alexandra), a countdown time to event 412 (for example, “32 hours left for the host to message you”), an event title 408 (e.g., “Malibu road trip”), a distance between the user device and the event 410 (e.g., 14 miles), and/or a view event detail button 414 configured to display the event detail screen 600 and accept button 416 to select events the user is interested in (FIGS. 6A-6C).

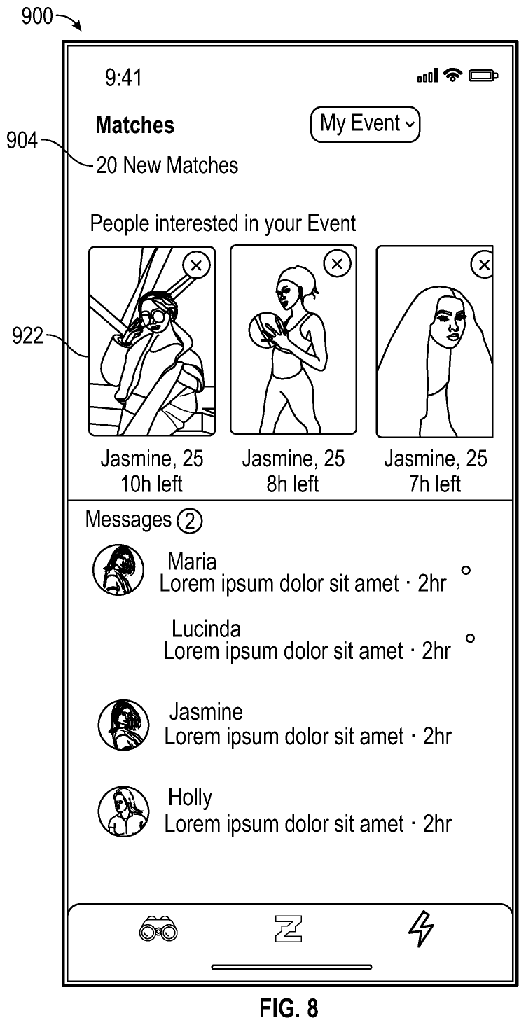

The application may also include a button bar 450, which includes a discover button 420 configured to open the discovery screen 400, a shopping cart button 430 configured to open a shopping cart screen, and/or a engage button 440 configured to open an engagement screen 800 (FIG. 8).

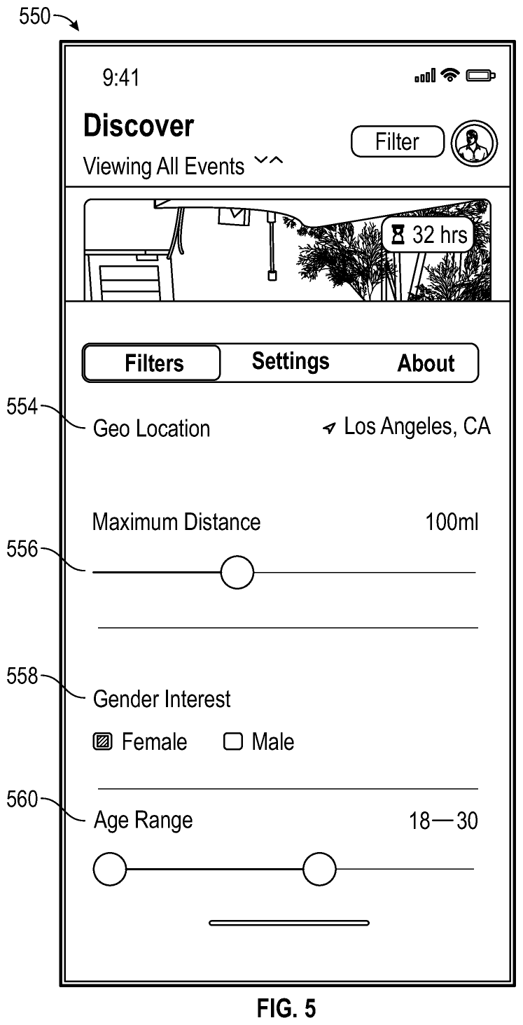

Referring to FIG. 5, an exemplary wireframe of a discovery filter screen 550 is shown in accordance with the present disclosure. In aspects, a category filter screen allows for the filtering of events by category as a user goes “shopping” for events. A check box and a description of the category may be used to help a user narrow the selection of available events. A checkmark or other indicia may be used to show when a category is selected for use in filtering the available events. For example, category may be filtered by one or more of arts, crafts, adventure, classes, sports, fitness, recreational, food, drink, events, shows, local attractions, vehicles, and/or all events. In aspects, the user may narrow by other preferences such as geolocation 554 (e.g., NY City, NY), maximum distance to the event 556, gender interest 558 (e.g., male and/or female), and/or age range 560 (e.g., 18-26 years old). Thus, the filtering may be further based on at least one of a maximum geographic distance between the user and each event of the plurality of events, a gender interest, and/or an age range. It is contemplated that an indicator may be displayed that indicates a number of events in a category. For example, the number “3” may be displayed next to “adventure” to indicate that there are three events within the radius that are in the Adventure category. This has the benefit of making event selection faster and more convenient.

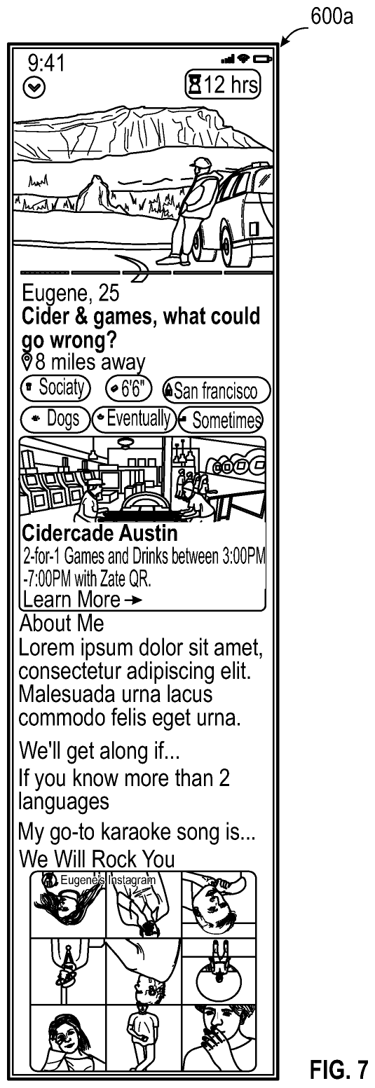

Referring to FIGS. 6A-6C and 7, exemplary wireframes of event detail screens are shown in accordance with the present disclosure. The event detail screen 600 generally includes an image window 403 configured to show an image chosen by the event planner, an event planner name 406 (e.g., Alexandra), a countdown time to event 412 (for example, “32 hours left for the host to message you”), an event title 408 (e.g., “Malibu road trip”), a distance between the user device and the event 410 (e.g., 14 miles), various profile details 602 (such as height, relationship status, etc.), a detailed description 604 of the event, an event location 607 (e.g., Malibu), a map image of the event location 606, a checklist of things needed for the event 608 (e.g., flippers, swimsuit, etc.), a window displaying the event planner's social media 626, an “about me” section 632 configured to display details about the profile owner, a “we'll get along” section 628 configured to display some user supplied detail about the profile owner, a favorite song section 629 configured to display a user's favorite song or go to karaoke song, a reject button 622 and an accept button 624. It is contemplated that the map may include a radius style indicator. The radius style indicator has the benefit of keeping the exact location more secure for the event creator (e.g., protecting users), so that a “shopper” does not know the exact location until the creator of the event approves them. The event detail screen 600 may include a venue detail screen 600a (FIG. 6C and FIG. 7), The venue event detail screen 600 may include a window displaying images of the venue 630, a window displaying details about the venue 631, and/or a window displaying further details 634 about the event at the venue.

In aspects, the user may display one or more current events that they have booked as well as display old events that they booked that have already passed. The user may also see how many likes an event has gotten from other users.

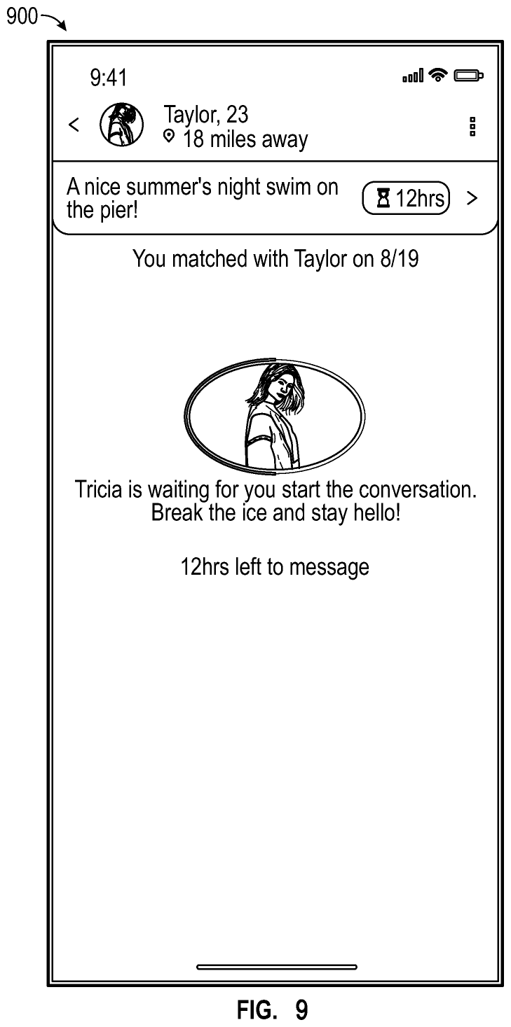

FIGS. 8 and 9 are exemplary wireframes of messages screens 900 of an aspect of the system of FIG. 1. The application may enable messaging between users. The messaging screen 900 may be accessed from any of the other screens using a messaging icon (not shown). The messaging screen 900 generally includes a fresh matches indicator 904 configured to display new matches to other users, a “your message” sub-window 908 that displays the other user's name (e.g., Julia), a short preview 912 of the message, an indication of how long ago the message was sent 906 (e.g., “30 minutes ago”), and a message counter 914 configured to display a count of messages by the same user. The messaging screen 900 may further include a header indicating an event and event details that is correlated with one or more of the users displayed 922 that are interested in the event. The header may include a color to indicate who the event belongs to. For example, the header may be colored green if the displayed event belongs to the user, or purple if it belongs to another user. It is contemplated that other colors may be used to indicate event ownership.

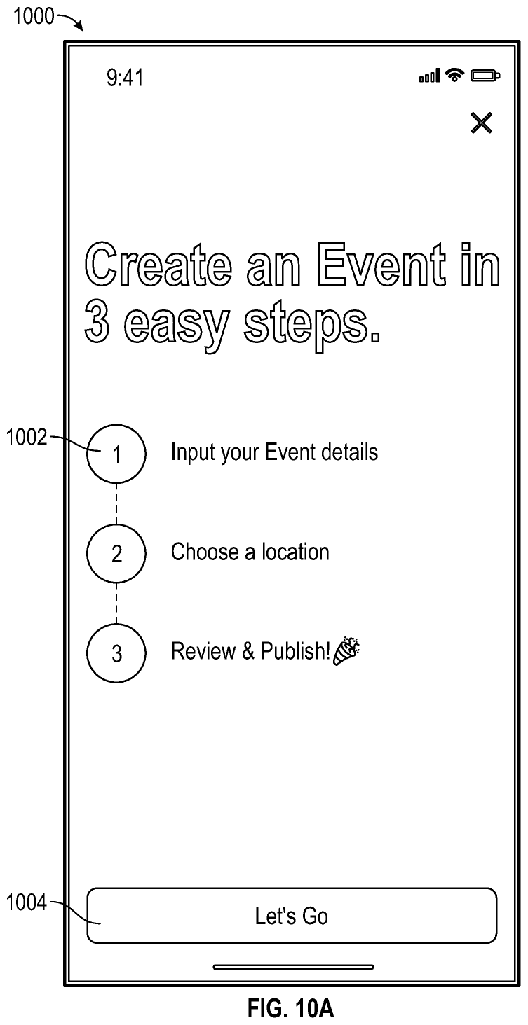

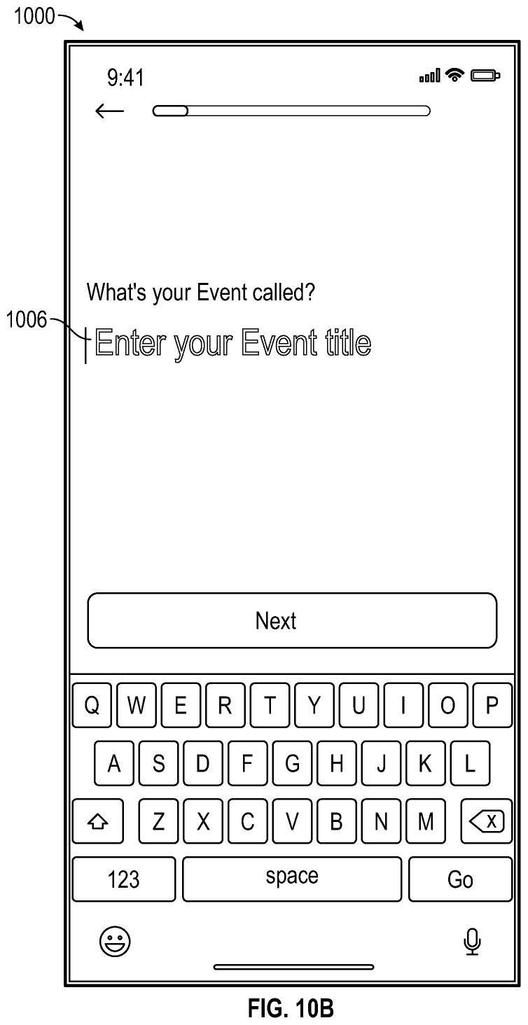

Referring to FIGS. 10A-10B, example wireframes of an event creation screen 1000 are shown. For example, if a user clicks on the “my event” button 430 (FIG. 4) they may be presented with a screen to create an event. It is contemplated that a user may reuse events that were previously created by themselves or other users. Initially, the user may be presented with a window 1000 showing how to create an event and a button 1002 configured to begin the process. The user may create an event in several easy steps, for example 1) input event details in one or more detail entry window(s) 1006 (e.g., name of event, description, things required, time, select one or more categories, etc.), 2) choose a location, and 3) publish the event with publish button 1004 for people to “shop” for. The aspects disclosed herein are examples of the disclosure and may be embodied in various forms. For instance, although certain aspects herein are described as separate aspects, each of the aspects herein may be combined with one or more of the other aspects herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an aspect,” “in aspects,” “in various aspects,” “in some aspects,” or “in other aspects” may each refer to one or more of the same or different aspects in accordance with the present disclosure. A phrase in the form “A or B” means “(A), (B), or (A and B).” A phrase in the form “at least one of A, B, or C” means“(A); (B); (C); (A and B); (A and C); (B and C); or (A, B, and C).”

Any of the herein described methods, programs, algorithms, or codes may be converted to, or expressed in, a programming language or computer program. The terms “programming language” and “computer program” as used herein, each includes any language used to specify instructions to a computer and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, scripting languages, Visual Basic, metalanguages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program where the programming language could exist in more than one state (such as source, compiled, object, or linked) is a reference to any and all such states. Reference to a program may encompass the actual instructions and/or the intent of those instructions.

It should be understood that the foregoing description is only illustrative of the present disclosure. Various alternatives and modifications can be devised by those skilled in the art without departing from the disclosure. Accordingly, the present disclosure is intended to embrace all such alternatives, modifications, and variances. The aspects described with reference to the attached drawing figures are presented only to demonstrate certain examples of the disclosure. Other elements, steps, methods, and techniques that are insubstantially different from those described above and/or in the appended claims are also intended to be within the scope of the disclosure. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method of location-based event matching comprising:
receiving by a server from a first user device, a plurality of events, wherein each event of the plurality of events includes a geographic location and a user profile of an event creator;
transmitting to the first user device, an indication to display a graphical representation of the transmitted plurality of events;
receiving by the server, from the first user device, a preference indication for an event of the plurality of events;
determining, by the server, a potential match based on the geographic location and the preference indication;
transmitting to a second user device, an indication to display a graphical representation of the determined potential match;
receiving by the server, from the second user device, an approval of the potential match as an approved match; and
transmitting, by the server, to the first user device, an indication to display a graphical representation of the approved match.

2. The computer-implemented method of claim 1, wherein each event of the plurality of events further includes at least one of a description of the event, a time, a date, or a category.

3. The computer-implemented method of claim 1, wherein displaying the plurality of events comprises:
filtering the plurality of events to be displayed on the user device based on a category; and
displaying, on the user device, a graphical representation of the filtered plurality of events.

4. The computer-implemented method of claim 3, wherein the category includes at least one of arts, crafts, adventure, classes, sports, fitness, recreational, food, drink, events, shows, local attractions, vehicles, or all events.

5. The computer-implemented method of claim 3, wherein the filtering is further based on at least one of a maximum geographic distance between the user and each event of the plurality of events, a gender interest, or an age range.

6. The computer-implemented method of claim 1, wherein displaying the plurality of events comprises displaying at least one of a description of the event, a map of the event geographic location, a profile of the event creator, an indication of a countdown time until a start time of the event, or a checklist.

7. The computer-implemented method of claim 1, wherein receiving the preference indication for an event of the plurality of events comprises prompting the user to submit a preference indication for the event.

8. The computer-implemented method of claim 1, the further comprising:
after receiving the preference indication for an event of the plurality of events, storing in a shopping cart the least one event based on the received indication.

9. The computer-implemented method of claim 1, wherein receiving the preference indication for the event of the plurality of events comprises:
receiving from the user device, a detected gesture associated with the graphical representation of the plurality of events indicating preference for one of the events of the plurality of events.

10. The computer-implemented method of claim 1, wherein determining the potential match is further based on matching a user profile to an event creator profile.

11. A system for location-based event matching comprising:
a server including:
a processor; and
a memory, including instructions stored thereon, which when executed by the processor cause the system to:
receiving from a first device by the server, a plurality of events, wherein each event of the plurality of events includes a geographic location and a user profile of an event creator;
transmit to the first user device, an indication to display a graphical representation of the plurality of events;
receive by the server from the first user device, a preference indication for an event of the plurality of events;
determine, by the server, a potential match based on the geographic location and the preference indication;
transmit to the second user device, an indication to display a graphical representation of the potential match;
receive, from the second user device, approval of the potential match as an approved match; and
transmit to the first user device, an indication to display a graphical representation of the approved match.

12. The system of claim 11, wherein each event of the plurality of events further includes at least one of a description of the event, a time, a date, or a category.

13. The system of claim 11, wherein when displaying the plurality of events, the instructions, when executed by the processor, further cause the system to:
filter, by the server, the plurality of events to be displayed on the user device based on a category; and
transmit to the user device, a graphical representation of the filtered plurality of events for display.

14. The system of claim 13, wherein the category includes at least one of arts, crafts, adventure, classes, sports, fitness, recreational, food, drink, events, shows, local attractions, vehicles, or all events.

15. The system of claim 13, wherein the filtering is further based on at least one of a maximum geographic distance between the user and each event of the plurality of events, a gender interest, or an age range.

16. The system of claim 11, wherein when displaying the plurality of events, the instructions, when executed by the processor, further cause the system to:
transmit to the first user device at least one of a description of the event, a map of the event's geographic location, a profile of the event creator, an indication of a countdown time until a start time of the event, or a checklist for display.

17. The system of claim 11, wherein when receiving the preference indication for an event of the plurality of events, the instructions, when executed, further cause the system to:
transmit a prompt to the first user device for the user to submit a preference indication for the event.

18. The system of claim 11, wherein after receiving the preference indication for an event of the plurality of events, the instructions, when executed by the processor, further cause the system to:
store in a shopping cart the least one event based on the received indication.

19. The system of claim 11, wherein when receiving a preference indication for the instructions, when executed by the processor, further cause the system to:
receive a gesture associated with the graphical representation of the plurality of events indicating a preference for one of the events of the plurality of events, from the first user device.

20. A non-transitory computer-readable storage medium in which is stored a program for causing a computer to execute a computer-implemented method of location-based event matching, the method comprising:
receiving by a server from a first user device, a plurality of events, wherein each event of the plurality of events includes a geographic location and a user profile of an event creator;
transmitting by a server to the first user device, an indication to display a graphical representation of the transmitted plurality of events;
receiving by the server, from the first user device, a preference indication for an event of the plurality of events;
determining, by the server, a potential match based on the geographic location and the preference indication;
transmitting to a second user device, an indication to display a graphical representation of the determined potential match;
receiving by the server, from the second user device, approval of the potential match as an approved match; and
transmitting, by the server, to the first user device, an indication to display a graphical representation of the approved match.
